(19) United States
(12) Patent Application Publication
(10) Pub. No.: US 2026/0301072 A1
(43) Pub. Date: Oct. 1, 2026

(54) SYSTEM AND METHOD FOR OPTIMIZING REAL-TIME ECONOMIC INTELLIGENCE AND TOKENOMICS QUOTIENT (TQ) IMPACT TO MEASURE TRENDS, TRACK HISTORICAL DATA, AND DRIVE PREDICTIVE ANALYTICAL IMPACT IN STATE-FUNDED TOKEN ECOSYSTEMS

(71) Applicant: Michael A. Fesi, II, Houma, LA (US)

(72) Inventor: Michael A. Fesi, II, Houma, LA (US)

(21) Appl. No.: 19/552,455

(22) Filed: Feb. 27, 2026

Related U.S. Application Data
(60) Provisional application No. 63/777,884, filed on Mar. 26, 2025.

(51) Int. Cl. G06Q 40/04

(52) U.S. Cl. CPC G06Q 40/053; G06Q 40/0421; G06Q 40/0431

(57) ABSTRACT

A system for real-time economic intelligence within a state-funded token ecosystem includes a central processing unit that coordinates acquisition, processing, analytics, and visualization while using historical datasets for longitudinal forecasting. A data acquisition module collects, parses, and standardizes token transactions and economic indicators from blockchain networks, economic databases, regulatory platforms, and third-party providers. A data storage module maintains real-time logs, historical datasets, and predictive modeling artifacts. An integrated analytics module computes token metrics including velocity, liquidity, and retention. An artificial intelligence predictive modeling module forecasts fiscal ripple effects. A geo-fenced mapping module tracks token flows and lifecycle events and renders heat maps and token journey paths. A tokenomics quotient calculation module generates a Tokenomics Quotient (TQ). A network communication module secures exchanges. An external interfaces module exposes application programming interfaces. A dashboard visualization module presents real-time intelligence and risk assessments.

### CROSS-REFERENCE TO RELATED APPLICATION

The present application claims priority to U.S. Provisional Application No. 63/777,884 filed Mar. 26, 2025, titled “System And Method For Optimizing Real-Time Economic Intelligence And Tokenomics Quotient (Tq) Impact To Measure Trends, Track Historical Data, And Drive Predictive Analytical Impact In State-Funded Token Ecosystems,” which is hereby incorporated by reference in its entirety.

### TECHNICAL FIELD

The embodiments disclosed herein generally relate to systems and methods for real-time economic intelligence in state-funded token ecosystems using transaction analytics, AI-driven forecasting, geo-fenced token flow mapping, and multi-dimensional transaction impact analysis to support fiscal growth, economic stability, and data-driven decision-making.

### BACKGROUND

The rise of digital economies and blockchain-based financial systems has introduced new challenges and opportunities for governments, regulatory agencies, and financial institutions. Traditional economic models and forecasting tools rely heavily on quarterly reports, static datasets, and retrospective analysis, which limit their ability to capture real-time economic activity. As governments explore state-issued digital value systems, including but not limited to state-funded tokens (StFT), tokenized public benefits, programmable digital dollars (including dollar-twin ecosystems), and other jurisdiction-scoped digital currency or payment instruments, to facilitate public finance management, economic stimulus programs, and digital asset regulation, there is a growing need for more dynamic, real-time economic intelligence systems that can analyze and predict the impact of digital transactions on state economies.

One of the key limitations of existing economic intelligence platforms is their inability to merge real-time digital transaction data with historical economic indicators. Most government financial systems rely on aggregated macroeconomic reports that may not reflect the immediate effects of digital token circulation, liquidity shifts, or fiscal interventions. Additionally, while blockchain explorers and financial dashboards provide transaction history tracking, they lack advanced AI-driven predictive modeling that can forecast economic ripple effects and assess multi-dimensional transaction impacts.

Another crucial challenge in the industry is the lack of geo-fencing capabilities for token transactions. Governments need localized insights into how digital tokens move within specific regions, cities, or economic zones to make informed decisions about resource allocation, public investment, and regulatory oversight. However, most existing solutions treat token transactions as globally distributed events without the ability to segment and analyze transactions based on geographical and jurisdictional boundaries.

Additionally, current economic monitoring systems do not provide comprehensive multi-dimensional transaction impact analysis that evaluates factors like transaction velocity, liquidity retention, and economic stability indicators. This lack of granular analysis prevents policymakers from effectively assessing the efficiency of digital token ecosystems.

Furthermore, regulatory compliance and risk management remain significant concerns in state-backed digital finance initiatives. Many financial monitoring systems lack automated compliance oversight, making it difficult for authorities to detect anomalies, flag suspicious activities, and enforce regulatory mandates.

Lastly, the lack of seamless integration between economic intelligence platforms and external financial systems has hindered effective data sharing and decision-making. Government agencies, financial regulators, and economic advisors often work with fragmented datasets across different platforms, leading to delays in economic assessments and inefficient fiscal responses.

### SUMMARY OF THE INVENTION

This summary is provided to introduce a variety of concepts in a simplified form that is further disclosed in the detailed description of the embodiments and is not intended to identify key or essential inventive concepts of the claimed subject matter or to determine the scope of the claimed subject matter.

In one aspect, the disclosed system, method, or software product may include a data acquisition module that continuously collects token transaction data and external economic indicators from blockchain networks, economic databases, regulatory platforms, and third-party providers, parses heterogeneous payloads, and standardizes records into a normalized schema with timestamps and provenance so real-time activity can be aligned with archived indicators absent from conventional quarterly or static reporting tools.

In one aspect, a data storage module maintains real-time logs, historical economic datasets, structured feature stores, and predictive modeling artifacts, including columnar partitions with compression for audit logs and feature stores to improve analytical scan efficiency and reproducibility that fragmented legacy systems often lack.

In one aspect, an integrated analytics module processes the standardized records to compute token metrics including velocity, liquidity, and retention, derives correlation metrics across jurisdictions, and detects trend inflection points using vectorized queries and window functions for rolling aggregates to supply continuous longitudinal analysis that conventional dashboards do not generate in real time.

In one aspect, the integrated analytics module computes an Economic Velocity Rate that represents velocity of state-funded operating capital over parameterized windows by program, jurisdiction, merchant category, and time window, with a configurable circulation threshold N.

In one aspect, an artificial intelligence predictive modeling module trains and applies machine learning models to forecast liquidity shifts, revenue trajectories, and macroeconomic ripple effects from the analytics outputs, performs rolling-window model refresh for concept drift stabilization, and conducts anomaly detection to surface compliance risks faster than manual or retrospective review workflows.

In one aspect, a tokenomics quotient calculation module computes a Tokenomics Quotient (TQ) from weighted factors including token velocity, liquidity, retention, transaction diversity, and regional adoption, and can generate jurisdictional sub-indices to quantify localized ecosystem health with a single machine-updated measure. As used herein, Tokenomics Quotient (TQ) may also be referred to as a tokenomics index or tokenomics score.

In one aspect, a geo-fenced mapping module tracks token flows and lifecycle events within predefined geographic boundaries, renders heat maps and token journey paths, and issues alerts when zone-specific thresholds are exceeded to deliver localized visibility that conventional global-only views lack.

In one aspect, a network communication module manages authenticated and encrypted exchanges among internal components and external platforms, providing integrity and confidentiality for inter-module data flows and recording immutable references where required.

In one aspect, an external interfaces module exposes application programming interfaces that return predictive models, the Tokenomics Quotient (TQ), geo-fenced visualizations, Economic Velocity Rate outputs, and compliance alerts for use by third-party fiscal dashboards and regulatory systems, and returns outputs in a standardized schema with signed provenance to improve interoperability and auditability.

In one aspect, a dashboard visualization module presents real-time insights including predictive forecasts, token lifecycle tracking, risk assessments, jurisdictional overlays, and historical comparisons, exposes role-based access and tenant scoping so views and application programming interface outputs are filtered by jurisdiction, program, and user role, and supports configurable segmentation and policy simulations so decision makers can evaluate prospective actions before execution.

In one aspect, a central processing unit coordinates orchestration across the data acquisition module, the data storage module, the integrated analytics module, the artificial intelligence predictive modeling module, the tokenomics quotient calculation module, the geo-fenced mapping module, the network communication module, the external interfaces module, and the dashboard visualization module to achieve end-to-end real-time operation that addresses shortcomings in timeliness, locality, compliance monitoring, and cross-platform access found in conventional products and systems.

In some aspects, the system includes at least one computing device in operable communication with a network and an application server in operable communication with a user network to host an application program for receiving token transaction data and economic indicators, executing analytics and predictive models, computing the Tokenomics Quotient (TQ) and regional sub-indices, computing the Economic Velocity Rate, generating geo-fenced visualizations and alerts, and delivering results through the dashboard visualization module and the external interfaces module to client devices and external systems.

Other illustrative variations within the scope of the embodiments will become apparent from the detailed description provided hereinafter, and the detailed description and enumerated variations, while disclosing optional implementations, are intended for purposes of illustration only and are not intended to limit the scope of the embodiments.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the computing system infrastructure, according to some embodiments.

FIG. 2 illustrates an application program and modules in communication with the computing system, according to some embodiments.

FIG. 3A illustrates a workflow of the disclosed computing system for acquiring and normalizing data, integrating analytics, forecasting with an artificial intelligence predictive modeling module, and computing a Tokenomics Quotient (TQ).

FIG. 3B illustrates a continuation of the workflow in FIG. 3A, including geo-fenced mapping with zone alerts, dashboard visualization of results, secured exchanges, and API delivery.

FIG. 4 illustrates a flowchart of the system data flow, according to some embodiments; and

FIG. 5 illustrates a flow chart of the data transaction process, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The disclosed system may include a central processing unit that orchestrates operations among a data acquisition module, a data storage module, an integrated analytics module, an artificial intelligence predictive modeling module, a geo-fenced mapping module, a tokenomics quotient calculation module, a network communication module, an external interfaces module, and a dashboard visualization module. The central processing unit may execute containerized services on one or more servers, allocate processor and memory resources to streaming tasks, and schedule batch jobs that refresh models and indices. The data acquisition module may connect to blockchain networks, economic databases, regulatory platforms, and third-party providers, normalize heterogeneous payloads into a common schema, and attach timestamps and provenance tags. The data storage module may maintain an immutable event log, a feature store optimized for analytical joins, and a repository of predictive modeling artifacts, with support for columnar compression to reduce disk throughput. The integrated analytics module may operate over streaming and historical datasets to compute token metrics including velocity, liquidity, retention, and transaction diversity, and to derive correlation metrics and trend inflection points using vectorized queries and window functions that minimize latency. The artificial intelligence predictive modeling module may implement supervised and unsupervised models, such as gradient-boosted decision trees, recurrent neural networks for time series, and density-based anomaly scoring, selected and tuned by cross validation on rolling windows to stabilize forecasts. The geo-fenced mapping module may maintain region definitions, associate events with geographic tiles, and generate heat maps and token journey paths using spatial indexes. The tokenomics quotient calculation module may compute a Tokenomics Quotient (TQ) by applying configurable weights to velocity, liquidity, retention, transaction diversity, and regional adoption and may output jurisdictional sub-indices. The network communication module may authenticate sources, encrypt inter-module exchanges, and sign outbound results. The external interfaces module may expose application programming interfaces for programmatic access to the Tokenomics Quotient (TQ), predictive models, geo-fenced visualizations, and compliance alerts and may enforce role-based access and tenant segmentation so dashboard and application programming interface responses are filtered by jurisdiction, program cohort, and user role. The dashboard visualization module may present real-time insights, jurisdictional overlays, and policy simulation results on client devices, including controls that accept candidate parameters and return projected outcomes from the artificial intelligence predictive modeling module and the tokenomics quotient calculation module.

The integrated analytics module may compute an Economic Velocity Rate (EVR) metric from standardized transaction event logs, where the EVR is parameterized by a token class or program identifier, a jurisdiction or zone, a selectable time window, a configurable circulation threshold N, merchant or vendor categories, and recapture or tax events where applicable. The integrated analytics module may publish the EVR to the dashboard visualization module for display by geography, program, vendor class, and time, and may publish the EVR to the external interfaces module for programmatic access.

Conventional economic intelligence platforms often rely on static or periodic reporting and cannot merge live token activity with historical indicators at sufficient granularity, which delays visibility into liquidity shifts, regional adoption, and compliance risks. The disclosed system addresses this problem by unifying streaming token transaction data and external economic indicators in the data acquisition module, aligning them in the data storage module, and continuously analyzing them in the integrated analytics module under coordination of the central processing unit. The artificial intelligence predictive modeling module may produce rolling forecasts of liquidity and revenue that update as new events arrive, while the tokenomics quotient calculation module may summarize ecosystem health in a single machine-updated index that policy makers can track by region. The geo-fenced mapping module may surface localized surges and directional changes in token flows that global views miss. Geo-fencing may rely on merchant registration, licensed addresses, program zones, or approved vendor registries rather than continuous user tracking. Through the network communication module and the external interfaces module, results may be delivered securely and interoperably to existing fiscal dashboards and regulatory tools, reducing manual reconciliation and improving time to decision.

In practice and in use, the system may be utilized in cases where a treasury department pilots a state-funded token for targeted stimulus. The data acquisition module may ingest token transfer events from a designated blockchain and macroeconomic indicators from government databases while the integrated analytics module computes real-time velocity and retention for participating districts. The artificial intelligence predictive modeling module may forecast expected liquidity over the next fiscal quarter and flag anomalous token journeys associated with nonparticipating merchants. The tokenomics quotient calculation module may output a district-level Tokenomics Quotient (TQ), and the geo-fenced mapping module may render heat maps that reveal neighborhoods with low redemption. The dashboard visualization module may display trends and what-if scenarios for adjusting program parameters, and the external interfaces module may stream the Tokenomics Quotient (TQ) and alerts to a compliance portal used by regulators.

In this way, the system may provide a practical application that improves the functioning of computer networks used for fiscal analytics by reducing query latency through columnar storage, compression, vectorized computations, and window functions for rolling aggregates in the integrated analytics module, lowering network bandwidth via schema-normalized messages from the data acquisition module, and minimizing retraining costs through rolling-window model refresh in the artificial intelligence predictive modeling module to stabilize concept drift. The coordinated operation of the central processing unit with the network communication module may harden data integrity and confidentiality, while the external interfaces module may eliminate brittle, manual data handoffs using a standardized output schema with signed provenance identifiers for compatibility with fiscal dashboards and regulatory systems. Compared with conventional platforms, stakeholders may obtain localized, real-time intelligence, machine-generated forecasts, and actionable indices that support faster policy iteration with fewer compute resources and reduced operational overhead.

Various implementations relate to real-time economic intelligence in state-funded token ecosystems and are necessarily rooted in computer technology. The steps include collecting token transaction data and external economic indicators from blockchain networks, economic databases, regulatory platforms, and third-party providers by a data acquisition module; parsing and normalizing the token transaction data by a central processing unit to produce cleaned data; maintaining real-time logs, historical economic datasets, and predictive modeling artifacts in a data storage module; processing structured transaction data to identify economic trends and compute token metrics including velocity, liquidity, and retention by an integrated analytics module; generating predictive models that forecast ripple effects of token activity on liquidity and revenue by an artificial intelligence predictive modeling module; tracking token flows and lifecycle events within predefined geographic boundaries and generating heat maps and token journey paths by a geo-fenced mapping module; computing a Tokenomics Quotient (TQ) based on token velocity, liquidity, retention, transaction diversity, and regional adoption by a tokenomics quotient calculation module; managing encrypted data exchange among internal components and external platforms by a network communication module; providing application programming interfaces for secure integration with economic systems, regulatory bodies, and financial monitoring tools by an external interfaces module; and presenting real-time insights comprising the Tokenomics Quotient (TQ), predictive forecasts, and geo-fenced visualizations via an interactive user interface by a dashboard visualization module. These steps execute over distributed networks, operate on streaming and archived datasets at machine scale, involve training and inference of machine learning models, and render dynamic user interface elements, and therefore cannot be performed in the human mind or on pen and paper.

Implementations include executing one or more artificial intelligence models on a computing device, where the computing device runs the artificial intelligence predictive modeling module to train, evaluate, and apply model algorithms and mathematical functions using machine learning libraries on computer hardware. The artificial intelligence predictive modeling module may perform supervised forecasting and anomaly detection using machine learning models, including but not limited to neural network based time-series models, ensemble regression models, and sequence models, to generate liquidity and revenue trajectories and to identify atypical token journeys from structured transaction data. The computing device implements the artificial intelligence model when the artificial intelligence predictive modeling module ingests streaming features from the integrated analytics module, updates parameters on rolling windows stored in the data storage module, generates predictive outputs and risk or anomaly scores, and emits decisions that drive compliance alerts and policy simulations in the dashboard visualization module. The external interfaces module may serialize predictive outputs, Tokenomics Quotient (TQ) values, geo-fenced visualizations, and Economic Velocity Rate values using a standardized schema that includes signed provenance identifiers so downstream fiscal dashboards and regulatory systems verify lineage and authenticity.

The foregoing operations are inherently computer-based and cannot be performed in the human mind or on pen and paper due to the volume, velocity, and heterogeneity of token transaction data and external economic indicators communicated by the data acquisition module and secured by the network communication module. The coordinated execution of parallel tensor operations, vectorized feature pipelines, and continuous model inference improves real-time economic intelligence by reducing latency, stabilizing forecasts under concept drift, and enabling geo-fenced, jurisdiction-level predictions that conventional manual workflows cannot achieve. As such, these implementations amount to significantly more than merely gathering, analyzing, and outputting data, and provide a concrete technical solution to delayed, non-localized, and siloed fiscal analytics by producing machine-generated forecasts and anomaly signals at network scale for consumption via the external interfaces module.

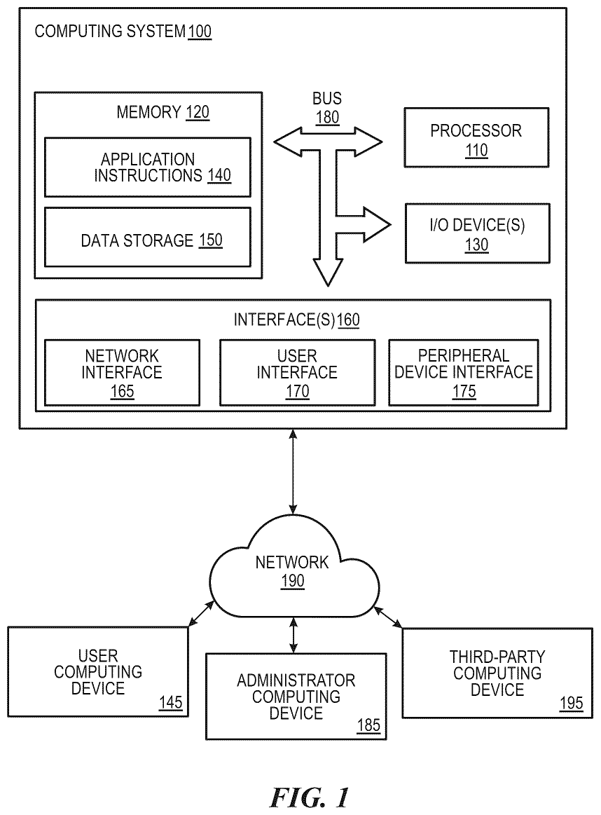

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

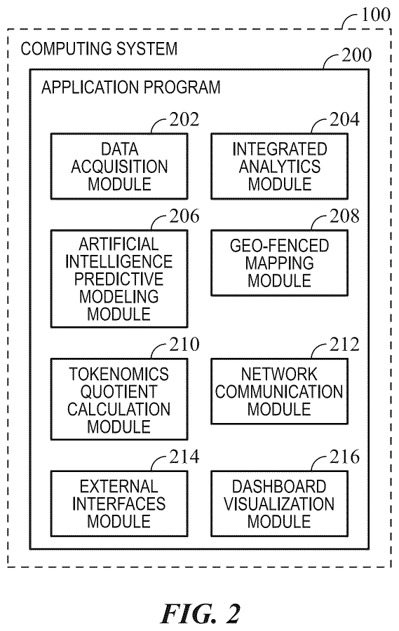

FIG. 2 illustrates an application program 200 executing on the computing system 100 of FIG. 1. The application program 200 may coordinate a pipeline that the central processing unit of FIG. 1 schedules across processor cores to operate the data acquisition module 202, the integrated analytics module 204, the artificial intelligence predictive modeling module 206, the geo-fenced mapping module 208, the tokenomics quotient calculation module 210, the network communication module 212, the external interfaces module 214, and the dashboard visualization module 216. The application program 200 may maintain configuration for data source credentials, feature definitions, geographic boundaries, alert thresholds, weighting profiles, role-based access policies, and retention periods, and the application program 200 may persist the configuration in the data storage module of FIG. 1 for audit and rollback.

The data acquisition module 202 may be a software component that establishes authenticated network connections to blockchain networks, economic databases, regulatory platforms, and third-party providers and ingests token transaction data and external economic indicators. The data acquisition module 202 may implement pull and push ingestion patterns, including node client polling for new blocks, subscription to message queues for market and macroeconomic indicators, and receipt of webhooks for regulatory notices. The data acquisition module 202 may parse heterogeneous payloads into a normalized schema by mapping source fields to canonical field names, coercing types, validating checksums, and attaching timestamps, source identifiers, and provenance signatures. The data acquisition module 202 may deduplicate events using composite keys, buffer records in an internal queue to sustain bursty input, and forward standardized records to the data storage module of FIG. 1 through the network communication module 212 using encrypted channels.

The integrated analytics module 204 may be a compute service that transforms standardized records into structured transaction data and derived metrics for downstream analysis. The integrated analytics module 204 may join streaming token transaction data with historical economic datasets stored in the data storage module of FIG. 1 and may compute token metrics including velocity, liquidity, retention, and transaction diversity. The integrated analytics module 204 may run vectorized queries and window functions over time bucketed partitions to maintain running aggregates, cohort statistics, and rolling correlations across jurisdictions. The integrated analytics module 204 may detect trend inflection points using piecewise linear fitting and change point scoring and may output correlation matrices that relate token flows to external economic indicators. The integrated analytics module 204 may materialize a structured dataset with stable column names, feature timestamps, and surrogate keys so the artificial intelligence predictive modeling module 206 and the tokenomics quotient calculation module 210 can read the structured dataset without additional transformation.

In some embodiments, the data acquisition module 202 may include a change data capture connector that tails append only logs from an economic database, and the integrated analytics module 204 may maintain a feature store keyed by wallet address, merchant identifier, and geographic tile so the artificial intelligence predictive modeling module 206 retrieves consistent features for training and inference across software releases.

The artificial intelligence predictive modeling module 206 may be a modeling service that trains, selects, and applies machine learning models to forecast ripple effects of token activity on liquidity and revenue and to identify anomalous transaction behavior. The artificial intelligence predictive modeling module 206 may construct feature tensors from the structured dataset produced by the integrated analytics module 204 using lag features, seasonal encodings, and jurisdiction identifiers. The artificial intelligence predictive modeling module 206 may train supervised forecasting models such as recurrent neural networks or temporal convolutional networks for multistep horizons and may train ensemble regression models such as gradient boosted decision trees to refine point estimates. The artificial intelligence predictive modeling module 206 may perform unsupervised anomaly detection using density-based scoring or isolation mechanisms to flag atypical token journeys. The artificial intelligence predictive modeling module 206 may evaluate candidate models on rolling windows, select a champion model per region, persist model artifacts and metrics in the data storage module of FIG. 1, and execute online inference to emit predictive outputs and risk scores to the dashboard visualization module 216 and the external interfaces module 214.

The tokenomics quotient calculation module 210 may be an index computation service that produces a Tokenomics Quotient (TQ) representing token ecosystem health. The tokenomics quotient calculation module 210 may receive metric inputs from the integrated analytics module 204, may normalize each factor to a common scale, may apply configurable weights to token velocity, liquidity, retention, transaction diversity, and regional adoption, and may compute jurisdictional sub-indices for regional comparisons. The tokenomics quotient calculation module 210 may annotate outputs with provenance that identifies input windows, weighting profiles, and source datasets and may persist index values and metadata in the data storage module of FIG. 1.

In some embodiments, the artificial intelligence predictive modeling module 206 may include a transformer-based sequence model to capture long range dependencies and may export calibrated prediction intervals for rendering by the dashboard visualization module 216, and the tokenomics quotient calculation module 210 may apply a time weighting function that emphasizes recent activity while preserving comparability with prior fiscal periods.

The geo-fenced mapping module 208 may be a spatial processing component that associates transaction events with predefined geographic boundaries and generates geo-fenced visual outputs. The geo-fenced mapping module 208 may maintain a spatial index of polygons that represent regions and economic zones, may perform point in polygon resolution to tag standardized records with region identifiers, and may compute heat maps by aggregating token transaction density in time windows. The geo-fenced mapping module 208 may reconstruct token journey paths by ordering events by timestamp and connecting origin and destination tiles. The geo-fenced mapping module 208 may generate a zone alert in response to a threshold exceeding change in token transaction density, directional flow, or velocity within a region and may publish alert records for downstream review by the dashboard visualization module 216 and consumption through the external interfaces module 214.

The network communication module 212 of FIG. 2 may be a transport and security service that manages encrypted data exchange among internal components and external platforms. The network communication module 212 of FIG. 2 may authenticate clients, negotiate cipher suites, rotate keys, attach integrity checks to message payloads, and attach signed provenance identifiers that bind payloads to source, timestamp, and configuration state. The network communication module 212 of FIG. 2 may provide blockchain anchored references for real time logs and predictive modeling artifacts by writing content identifiers to an immutable ledger and persisting artifacts in the data storage module of FIG. 1. The network communication module 212 of FIG. 2 may enforce rate limits, implement retries with backoff, and isolate traffic per tenant so agencies and programs access only authorized datasets.

The external interfaces module 214 of FIG. 2 may be an application programming interface service that exposes programmatic access to computed metrics, predictive outputs, geo fenced visualizations, and alerts. The external interfaces module 214 of FIG. 2 may provide read endpoints for the Tokenomics Quotient (TQ), predictive models, heat maps, token journey paths, and compliance alerts and may accept filter parameters for time ranges, regions, and program cohorts. The external interfaces module 214 of FIG. 2 may enforce role-based access and multi-tenant segmentation so responses are filtered by jurisdiction, program cohort, and user role, and the external interfaces module 214 of FIG. 2 may serialize responses using a standardized schema that includes signed provenance identifiers for downstream verification and interoperability.

In some embodiments, the geo-fenced mapping module 208 may support hierarchical grids for multi scale aggregation, the network communication module 212 may employ mutual Transport Layer Security with certificate pinning for inter service traffic within the computing system 100 of FIG. 1, and the external interfaces module 214 may expose a query language that returns token journey paths filtered by region with pagination metadata for reproducible analysis.

The dashboard visualization module 216 may be a presentation service that renders real time insights on client devices. The dashboard visualization module 216 may display token lifecycle tracking, predictive forecasts, geo-fenced heat maps, token journey paths, and risk assessments and may provide jurisdictional overlays, historical comparisons across fiscal periods, and drill down controls that segment token flows by region and lifecycle event. The dashboard visualization module 216 may retrieve historical data and model artifacts from the data storage module of FIG. 1 and may subscribe to live topics published by the external interfaces module 214 to update visualizations without a page reload.

In some embodiments, the dashboard visualization module 216 may include policy simulation controls that send candidate parameters to the artificial intelligence predictive modeling module 206 and the tokenomics quotient calculation module 210 so projected outcomes appear alongside live telemetry. The application program 200 may deploy each module shown in FIG. 2 as a containerized microservice, and the central processing unit of FIG. 1 may scale services horizontally in response to input volume while background jobs compact historical partitions in the data storage module of FIG. 1.

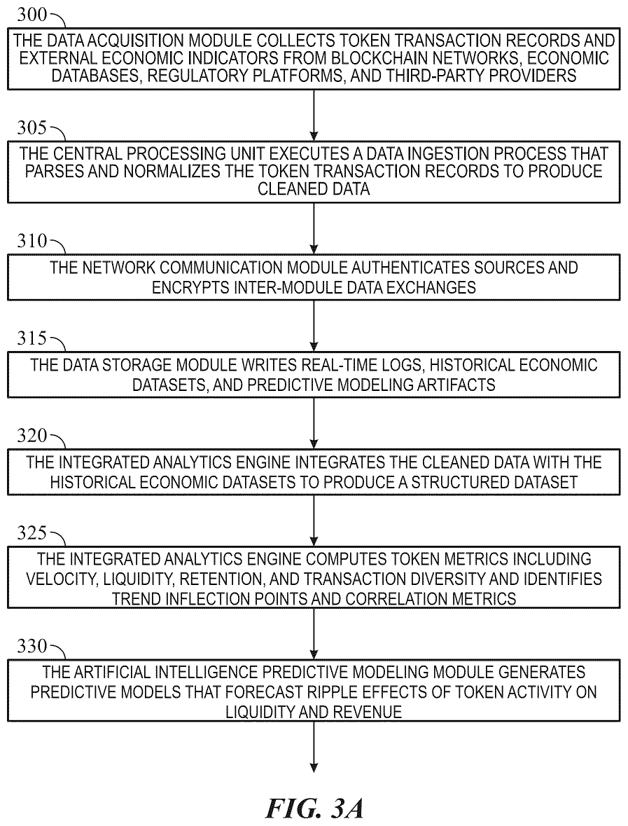

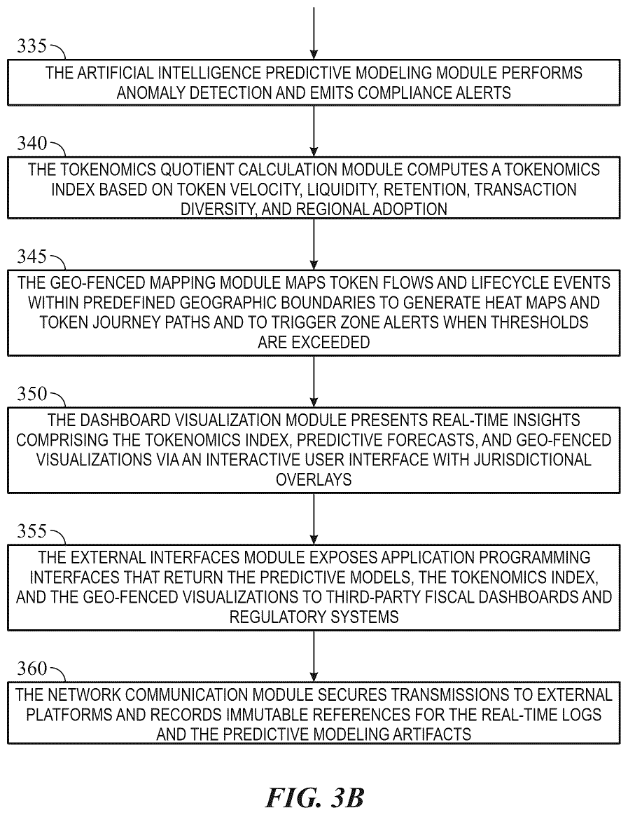

FIG. 3A depicts a first portion of a workflow executed by the application program 200 of FIG. 2 running on the computing system 100 of FIG. 1. The workflow of FIG. 3A progresses through Step 300, Step 305, Step 310, Step 315, Step 320, Step 325, and Step 330, with each step carried out by the specifically named module of FIG. 2 under coordination of the central processing unit of FIG. 1.

At Step 300, the data acquisition module 202 of FIG. 2 collects token transaction records and external economic indicators from blockchain networks, economic databases, regulatory platforms, and third-party providers. The data acquisition module 202 of FIG. 2 establishes authenticated sessions to node clients, subscribes to block and mempool streams, polls cursor endpoints on economic databases, and receives webhook payloads from regulatory platforms. The data acquisition module 202 of FIG. 2 buffers inbound items in an ingest queue, assigns source identifiers and receive timestamps, and forwards payloads to a parsing stage so arrival bursts do not stall downstream processing.

In some embodiments, the data acquisition module 202 of FIG. 2 includes a change data capture connector that tails append-only logs from an economic database and performs backfill when a gap is detected, and the data acquisition module 202 of FIG. 2 rate limits noisy sources to keep per-tenant throughput within configured limits.

At Step 305, the central processing unit of FIG. 1 executes a data ingestion process that parses and normalizes the token transaction records received from the data acquisition module 202 of FIG. 2 to produce cleaned data. The data ingestion process maps source fields to a canonical schema, coerces numeric, temporal, and geographic types, validates digital signatures and hashes, attaches provenance identifiers, and removes duplicates using composite keys that include transaction identifier, block height, and source identifier. The central processing unit of FIG. 1 writes parsing and validation outcomes to a status stream so failures can be inspected without halting the workflow.

In some embodiments, the central processing unit of FIG. 1 consults a schema registry used by the data acquisition module 202 of FIG. 2 and applies schema evolution rules that introduce newly discovered fields as nullable columns, allowing the integrated analytics module 204 of FIG. 2 to continue operating without redeployment.

At Step 310, the network communication module 212 of FIG. 2 authenticates sources and encrypts inter-module data exchanges. The network communication module 212 of FIG. 2 negotiates Transport Layer Security sessions, rotates keys on a schedule, signs payloads, and attaches integrity checks so downstream components verify origin and freshness. The network communication module 212 of FIG. 2 enforces retry with backoff and outbound throttling so transient faults or downstream slowness do not propagate upstream.

In some embodiments, the network communication module 212 of FIG. 2 employs mutual Transport Layer Security with certificate pinning and stores long-term keys in a hardware security module, and the network communication module 212 of FIG. 2 assigns tenant-scoped tokens so agencies receive only authorized streams.

At Step 315, the data storage module of FIG. 1 writes real-time logs, historical economic datasets, and predictive modeling artifacts produced by the preceding steps. The data storage module of FIG. 1 appends cleaned records to an immutable event log for audit, persists columnar partitions for analytical scans, maintains secondary indexes on wallet address, merchant identifier, and geographic tile to accelerate lookups, and stores versioned artifacts and metadata for models so analytical states can be reproduced.

At Step 320, the integrated analytics module 204 of FIG. 2 integrates the cleaned data with the historical economic datasets stored by the data storage module of FIG. 1 to produce a structured dataset. The integrated analytics module 204 of FIG. 2 performs windowed joins keyed by wallet address, merchant identifier, and geographic tile, derives features such as moving averages, lagged values, and seasonal encodings, and materializes a stable typed table with feature timestamps and surrogate keys so downstream components read the structured dataset without further transformation.

In some embodiments, the integrated analytics module 204 of FIG. 2 maintains a feature store keyed by wallet address, merchant identifier, and geographic tile and incrementally materializes only changed partitions so the artificial intelligence predictive modeling module 206 of FIG. 2 retrieves consistent features at low latency.

At Step 325, the integrated analytics module 204 of FIG. 2 computes token metrics including velocity, liquidity, retention, and transaction diversity and identifies trend inflection points and correlation metrics. The integrated analytics module 204 of FIG. 2 executes vectorized aggregations over time-bucketed partitions, applies change-point scoring to detect inflections, and calculates cross-region correlations that relate token activity to external indicators, then emits metric tables and correlation matrices for use in subsequent modeling and index computation.

At Step 330, the artificial intelligence predictive modeling module 206 of FIG. 2 generates predictive models that forecast ripple effects of token activity on liquidity and revenue. The artificial intelligence predictive modeling module 206 of FIG. 2 constructs feature tensors from the structured dataset, trains candidate models on rolling windows, selects a champion per region based on validation metrics, persists model artifacts and lineage in the data storage module of FIG. 1, and prepares an inference pipeline for the continuation shown in FIG. 3B.

In some embodiments, the artificial intelligence predictive modeling module 206 of FIG. 2 employs recurrent neural networks or temporal convolutional networks for multistep forecasts, augments point estimates with calibrated prediction intervals for later visualization by the dashboard visualization module 216 of FIG. 2, or uses a transformer-based sequence model to capture long-range temporal dependencies across fiscal periods.

FIG. 3B depicts a continuation of the workflow executed by the application program 200 of FIG. 2 on the computing system 100 of FIG. 1. The workflow of FIG. 3B progresses through Step 335, Step 340, Step 345, Step 350, Step 355, and Step 360, with each step carried out by the specifically named module of FIG. 2 under coordination of the central processing unit of FIG. 1.

At Step 335, the artificial intelligence predictive modeling module 206 of FIG. 2 performs anomaly detection and emits compliance alerts. The artificial intelligence predictive modeling module 206 of FIG. 2 loads the champion model selected in FIG. 3A, reads feature tensors from the structured dataset written at Step 320, computes inference outputs for each token journey, and assigns a risk score and reason codes derived from feature attributions. The artificial intelligence predictive modeling module 206 of FIG. 2 writes alert candidates with timestamps, region identifiers, and model version identifiers to the data storage module of FIG. 1 so downstream systems can audit decisions.

In some embodiments, the artificial intelligence predictive modeling module 206 of FIG. 2 maintains region specific baselines and applies jurisdiction parameters received through the external interfaces module 214 of FIG. 2 to adjust sensitivity without retraining.

At Step 340, the tokenomics quotient calculation module 210 of FIG. 2 computes a Tokenomics Quotient (TQ) using weighted factors that include token velocity, liquidity, retention, transaction diversity, and regional adoption and may output jurisdictional sub indices. The tokenomics quotient calculation module 210 of FIG. 2 normalizes inputs to a common scale, applies configured weights, smooths short term noise with an exponential moving average, and emits an index value with a confidence metric. The tokenomics quotient calculation module 210 of FIG. 2 records the weighting profile, input windows, and data lineage in the data storage module of FIG. 1 for reproducibility.

In some embodiments, the tokenomics quotient calculation module 210 of FIG. 2 applies a time weighting function that emphasizes recent activity while preserving comparability across fiscal periods, or computes percentile ranks so regions can be compared on a unified scale.

At Step 345, the geo-fenced mapping module 208 of FIG. 2 maps token flows and lifecycle events within predefined geographic boundaries to generate heat maps and token journey paths and triggers a zone alert when thresholds are exceeded. The geo-fenced mapping module 208 of FIG. 2 performs point in polygon resolution against a spatial index, aggregates counts per tile and interval, constructs path segments ordered by timestamp, and attaches journey identifiers so paths are traceable across sessions. The geo-fenced mapping module 208 of FIG. 2 publishes map tiles, journey overlays, and alert records to the data storage module of FIG. 1 and notifies subscribers that new visual layers are available.

In some embodiments, the geo-fenced mapping module 208 of FIG. 2 uses a hierarchical grid so aggregates roll up consistently from neighborhood to city to region, and may attach device location attestations where available to strengthen provenance.

At Step 350, the dashboard visualization module 216 of FIG. 2 presents real time insights comprising the Tokenomics Quotient (TQ), predictive forecasts, compliance alerts, and geo-fenced visualizations via an interactive user interface with jurisdictional overlays. The dashboard visualization module 216 of FIG. 2 renders layered heat maps and token journey paths, draws time series for index values and forecast trajectories, highlights active alerts with risk scores and reason codes, and offers drill down controls that filter by region, timeframe, and lifecycle event. The dashboard visualization module 216 of FIG. 2 retrieves historical data and model artifacts from the data storage module of FIG. 1 and subscribes to streaming topics exposed by the external interfaces module 214 of FIG. 2 for live updates.

In some embodiments, the dashboard visualization module 216 of FIG. 2 renders forecast cones using calibrated prediction intervals provided by the artificial intelligence predictive modeling module 206 of FIG. 2 and includes policy simulation controls that preview projected outcomes alongside live telemetry.

At Step 355, the external interfaces module 214 of FIG. 2 exposes application programming interfaces that return predictive models, Tokenomics Quotient (TQ) values, geo fenced visualizations, and alert data to third party fiscal dashboards and regulatory systems. The external interfaces module 214 of FIG. 2 serves request response endpoints for historical queries with pagination and version identifiers, publishes streaming topics for subscribers that require low latency notifications, and serializes outputs to a standardized schema that includes signed provenance identifiers to support lineage verification and cross system compatibility. The external interfaces module 214 of FIG. 2 validates caller authorization against role-based policies maintained by the application program 200 of FIG. 2, applies jurisdiction and program cohort filters to each response, and records access events in the data storage module of FIG. 1.

In some embodiments, the external interfaces module 214 of FIG. 2 accepts configuration updates for geographic boundaries, alert thresholds, and weighting profiles and stages such updates for scheduled activation to avoid mid cycle metric shifts.

At Step 360, the network communication module 212 of FIG. 2 secures transmissions to external platforms and records immutable references for the real time logs and the predictive modeling artifacts. The network communication module 212 of FIG. 2 authenticates the destination, encrypts payloads, attaches integrity checks, schedules retries with backoff for transient failures, and writes content identifiers to a blockchain ledger while persisting the corresponding payloads in the data storage module of FIG. 1 for retrieval. The network communication module 212 of FIG. 2 logs success or failure per transmission so the application program 200 of FIG. 2 can reconcile external delivery.

In some embodiments, the network communication module 212 of FIG. 2 uses mutual Transport Layer Security with certificate pinning and tenant scoped tokens so agencies and programs receive only authorized datasets.

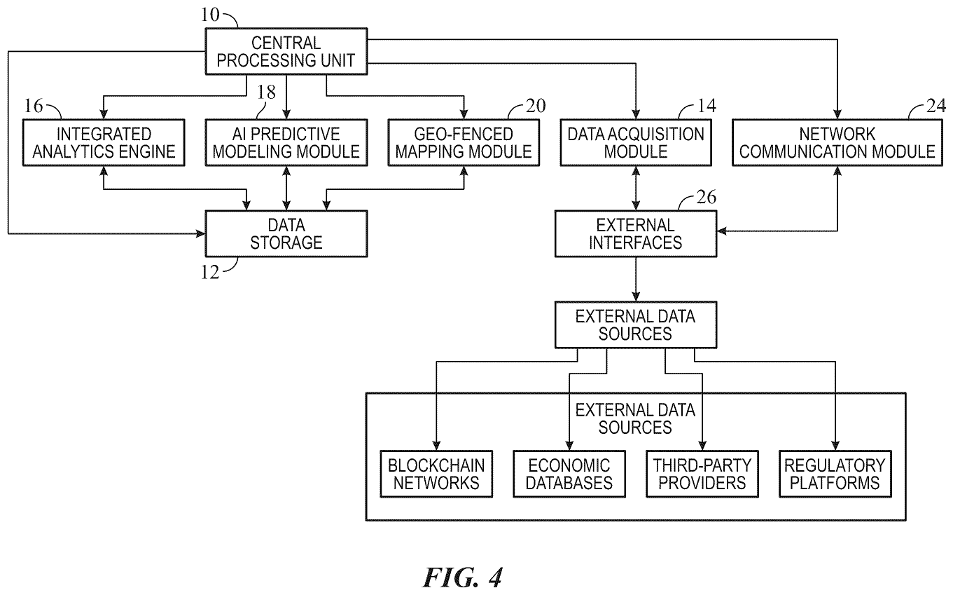

FIG. 4 illustrates a schematic diagram of the distributed computing system architecture that includes a central processing unit of FIG. 1, an integrated analytics module 204 of FIG. 2, an artificial intelligence predictive modeling module 206 of FIG. 2, a geo-fenced mapping module 208 of FIG. 2, a data acquisition module 202 of FIG. 2, and a network communication module 212 of FIG. 2. The central processing unit of FIG. 1 orchestrates system operations, executing real time analytics and predictive modeling. The integrated analytics module 204 of FIG. 2 processes transaction data and merges insights from the data acquisition module 202 of FIG. 2 and the data storage module of FIG. 1. The artificial intelligence predictive modeling module 206 of FIG. 2 forecasts economic impact using machine learning. The geo-fenced mapping module 208 of FIG. 2 tracks token movements and lifecycle events within specific regions. The data acquisition module 202 of FIG. 2 interfaces with external economic databases, blockchain networks, and regulatory platforms to collect transaction data. The network communication module 212 of FIG. 2 manages secure data exchange to external data sources via an external interfaces module 214 of FIG. 2.

In some embodiments, the central processing unit of FIG. 1 executes core logic for real-time analytics, AI-driven forecasting, and geo-fenced transaction tracking. The central processing unit of FIG. 1 manages communication between internal components and ensures that incoming data is processed efficiently for economic modeling and decision-making.

In some embodiments, the integrated analytics module 204 of FIG. 2 is responsible for real-time processing of incoming transaction data. The integrated analytics module 204 of FIG. 2 merges insights from historical economic datasets, live blockchain transactions, and external financial sources to generate structured, actionable intelligence. The integrated analytics module 204 of FIG. 2 enables multi-dimensional transaction analysis, identifying patterns and anomalies used for economic planning.

In some embodiments, the artificial intelligence predictive modeling module 206 of FIG. 2 utilizes machine learning algorithms to assess ripple effects of token transactions on state economies. The artificial intelligence predictive modeling module 206 of FIG. 2 generates short-term and long-term forecasts by analyzing token flow trends, economic stability indicators, and fiscal impact scenarios.

In some embodiments, the geo-fenced mapping module 208 of FIG. 2 applies virtual geographic boundaries to digital transactions, allowing the system to track token circulation within specific economic zones, cities, or state-defined regions. The geo-fenced mapping module 208 of FIG. 2 generates heat maps and lifecycle insights to enable assessment of localized economic impacts and fiscal strategy adjustments.

In some embodiments, the data acquisition module 202 of FIG. 2 serves as a data gateway, pulling real-time transaction records from blockchain networks, regulatory databases, economic reporting platforms, and third-party data providers. The data acquisition module 202 of FIG. 2 supplies a continuous stream of structured financial data that maintains up-to-date economic intelligence.

In some embodiments, the data storage module of FIG. 1 maintains a repository of historical and contemporary economic data. The data storage module of FIG. 1 securely stores real-time transaction logs, processed datasets, artificial intelligence modeling outputs, and fiscal projections to support long-term trend analysis.

In some embodiments, the network communication module 212 of FIG. 2 manages secure data transmission across internal components and external platforms. The network communication module 212 of FIG. 2 enables encrypted data exchange between blockchain networks, economic databases, and state financial agencies and supports compliance with financial security standards and data privacy policies.

In some embodiments, the external interfaces module 214 of FIG. 2 connects the system to blockchain networks, government financial systems, third-party economic indicators, and regulatory platforms. The external interfaces module 214 of FIG. 2 facilitates data sharing between private and public sector entities so that stakeholders access real-time insights and predictive forecasts for fiscal planning.

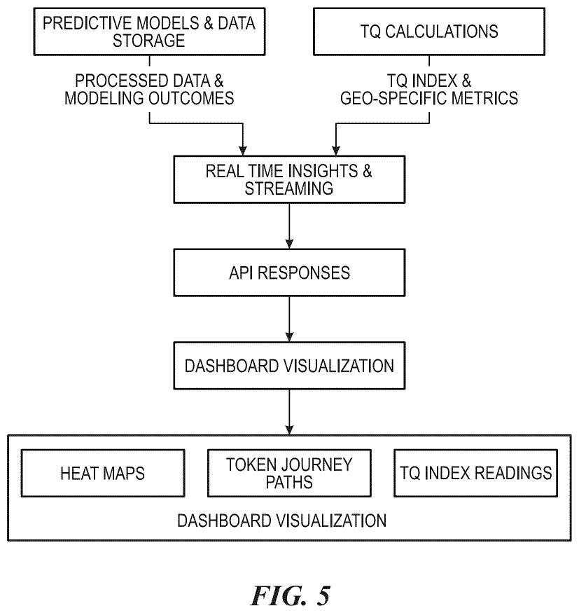

FIG. 5 illustrates a layered workflow in which external data sources provide token transaction records, economic datasets, and regulatory information that feed the data acquisition module 202 of FIG. 2 operating on the computing system 100 of FIG. 1. The data acquisition module 202 of FIG. 2 maintains authenticated connections to blockchain networks, economic databases, and regulatory platforms so the application program 200 of FIG. 2 maintains comprehensive visibility into activity within a state funded token ecosystem.

A data ingestion stage standardizes incoming records by invoking the central processing unit of FIG. 1 to execute parsing, deduplication, and validation for payloads received by the data acquisition module 202 of FIG. 2. The central processing unit of FIG. 1 maps fields to a canonical schema, verifies signatures and hashes, and filters irrelevant or malformed items so downstream processing receives cleaned data.

A processing stage converts the cleaned data into structured analytics by invoking the integrated analytics module 204 of FIG. 2. The integrated analytics module 204 of FIG. 2 derives token velocity, retention, liquidity, and transaction diversity and produces a structured dataset used by subsequent modeling and visualization components.

The artificial intelligence predictive modeling module 206 of FIG. 2 applies trained models to the structured dataset to identify patterns and forecast liquidity risks, inflationary trends, and fiscal sustainability scenarios. The artificial intelligence predictive modeling module 206 of FIG. 2 outputs predictive trajectories and risk scores that the dashboard visualization module 216 of FIG. 2 renders for policy evaluation.

The tokenomics quotient calculation module 210 of FIG. 2 computes a Tokenomics Quotient (TQ) based on token velocity, liquidity, retention, transaction diversity, and regional adoption. The tokenomics quotient calculation module 210 of FIG. 2 provides a standardized benchmark for evaluating ecosystem health across jurisdictions and across fiscal periods.

The dashboard visualization module 216 of FIG. 2 delivers real time insights to stakeholders by rendering live charts, geo-fenced layers, and index readings. The dashboard visualization module 216 of FIG. 2 updates views as the artificial intelligence predictive modeling module 206 of FIG. 2 and the tokenomics quotient calculation module 210 of FIG. 2 publish new results, enabling responsive fiscal planning.

The external interfaces module 214 of FIG. 2 exposes application programming interfaces that return predictive models, Tokenomics Quotient (TQ) values, and geo-fenced visualizations to third party fiscal dashboards and regulatory systems. The external interfaces module 214 of FIG. 2 enables secure integration with existing government financial infrastructure by enforcing role based access and tenant segmentation so responses are filtered by jurisdiction, program cohort, and user role, and by serializing outputs to a standardized schema that includes signed provenance identifiers for downstream lineage verification.

The geo-fenced mapping module 208 of FIG. 2 generates heat maps and token journey paths from the structured dataset and attaches alerts when configured thresholds within predefined geographic boundaries are exceeded. The geo-fenced mapping module 208 of FIG. 2 supplies map tiles and overlays consumed by the dashboard visualization module 216 of FIG. 2.

The data storage module of FIG. 1 preserves real time logs, historical economic datasets, structured analytics, model artifacts, and Tokenomics Quotient (TQ) outputs generated by the components of FIG. 2 so longitudinal studies and regulatory audits can be performed.

During acquisition and integration, the data acquisition module 202 of FIG. 2 receives live blockchain transactions, historical economic datasets, and macroeconomic indicators, while the central processing unit of FIG. 1 attaches timestamps, provenance identifiers, and geolocation where available. During analytics, the integrated analytics module 204 of FIG. 2 merges the live and historical streams to produce the structured dataset for use by the artificial intelligence predictive modeling module 206 of FIG. 2.

In some embodiments, the artificial intelligence predictive modeling module 206 of FIG. 2 trains recurrent neural networks, temporal convolutional networks, or transformers on the structured dataset to produce multistep forecasts, and the artificial intelligence predictive modeling module 206 of FIG. 2 emits anomaly scores to support compliance review.

The geo-fenced token flow and lifecycle tracking functions are performed by the geo-fenced mapping module 208 of FIG. 2, which associates events to predefined geographic boundaries and reconstructs token journeys and lifecycle events from issuance through redemption.

In some embodiments, the artificial intelligence predictive modeling module 206 of FIG. 2 produces real time forecasts for revenue and risk and the data storage module of FIG. 1 archives both the structured dataset and model outputs to enable iterative retraining and backtesting.

The tokenomics quotient calculation module 210 of FIG. 2 applies a weighting profile to the derived metrics to compute the Tokenomics Quotient (TQ) and may refresh the Tokenomics Quotient (TQ) on a schedule synchronized to data availability so stakeholders evaluate current conditions.

In some embodiments, the tokenomics quotient calculation module 210 of FIG. 2 computes jurisdictional sub-indices and percentile ranks to support cross region comparison within the dashboard visualization module 216 of FIG. 2.

In some embodiments, the dashboard visualization module 216 of FIG. 2 provides live alert panels and streaming updates that surface predicted risks and compliance exceptions as the artificial intelligence predictive modeling module 206 of FIG. 2 publishes new scores.

The application program 200 of FIG. 2 provides dashboard and application programming interface access through the dashboard visualization module 216 of FIG. 2 and the external interfaces module 214 of FIG. 2 so government officials, economists, and auditors consume real time insights, forecasts, and alerts.

In some embodiments, the dashboard visualization module 216 of FIG. 2 presents interactive charts, maps, token journey paths, and Tokenomics Quotient (TQ) readings with configurable filters and historical overlays, and the dashboard visualization module 216 of FIG. 2 supports automated reporting for policy discussions.

In some embodiments, the external interfaces module 214 of FIG. 2 returns predictive forecasts, Tokenomics Quotient (TQ) values, and geo-fenced visualizations to approved external platforms through authenticated and encrypted endpoints provided in conjunction with the network communication module 212 of FIG. 2. The external interfaces module 214 of FIG. 2 may apply jurisdiction and program cohort filters to each response and serialize payloads to a standardized schema that includes signed provenance identifiers to support interoperability and auditability.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

What is claimed is:

1. A system for real-time economic intelligence and transaction analysis within a state-funded token ecosystem, the system comprising:
a central processing unit configured to coordinate data acquisition, processing, analytics, and visualization in real time while processing historical datasets to enable longitudinal forecasting;
a data acquisition module configured to collect, parse, and standardize token transaction data and economic indicators from blockchain networks, economic databases, regulatory platforms, and third-party providers;
a data storage module configured to maintain real-time logs, historical economic datasets, and predictive modeling artifacts;
an integrated analytics module configured to process structured transaction data, identify economic trends, and compute token metrics including velocity, liquidity, retention, and an economic velocity rate (EVR) computed from standardized transaction event logs and parameterized by at least a program identifier, a jurisdiction or zone, and a selectable time window;
an artificial intelligence predictive modeling module configured to forecast ripple effects of token transactions on fiscal outcomes using models trained on the structured transaction data and the historical economic datasets;
a geo-fenced mapping module configured to track token flows and lifecycle events within predefined geographic boundaries and to generate heat maps and token journey paths;
a tokenomics quotient calculation module configured to compute a Tokenomics Quotient (TQ) based on token velocity, liquidity, retention, transaction diversity, and regional adoption;
a network communication module configured to manage encrypted data exchange among internal components and external platforms;
an external interfaces module configured to provide application programming interfaces for secure integration with economic systems, regulatory bodies, and financial monitoring tools; and
a dashboard visualization module configured to present real-time economic intelligence including predictive analytics, token lifecycle tracking, and risk assessments through an interactive user interface.

2. The system of claim 1, wherein the artificial intelligence predictive modeling module applies time-series models and deep neural models to improve accuracy of projections regarding liquidity changes, revenue projections, and macroeconomic trends.

3. The system of claim 1, wherein the geo-fenced mapping module automatically triggers an alert responsive to a detected transaction surge within an economic zone defined by the predefined geographic boundaries, and wherein the predefined geographic boundaries are enforced using merchant registration, licensed address, program zone definitions, or approved vendor registries without continuous user location tracking.

4. The system of claim 1, wherein the tokenomics quotient calculation module assigns dynamic weights to token adoption rate, liquidity shifts, and transaction diversity when computing the Tokenomics Quotient (TQ).

5. The system of claim 1, wherein the data storage module stores the real-time logs and the historical economic datasets as columnar partitions with compression configured to reduce disk throughput during analytical scans.

6. The system of claim 1, wherein the integrated analytics module executes vectorized queries and window functions over time-bucketed partitions to compute rolling aggregates and correlation metrics.

7. The system of claim 1, wherein the artificial intelligence predictive modeling module performs rolling-window model refresh and concept drift stabilization responsive to updates in the structured transaction data.

8. The system of claim 1, wherein the external interfaces module and the network communication module enforce role-based access controls and tenant scoping so dashboard and application programming interface responses are filtered by jurisdiction, program, and user role.

9. The system of claim 1, wherein the dashboard visualization module provides policy simulation controls that accept candidate parameters and display projected outcomes generated by the artificial intelligence predictive modeling module and the tokenomics quotient calculation module.

10. The system of claim 1, wherein the external interfaces module returns outputs in a standardized schema with signed provenance that identifies input windows, weighting profiles, and model version identifiers.

11. A computer-implemented method for generating real-time economic intelligence within a state-funded token ecosystem, the method comprising: acquiring, by the data acquisition module, token transaction records and external economic indicators from blockchain networks, economic databases, regulatory platforms, and third-party providers;
normalizing, by a data ingestion process executed by the central processing unit, the token transaction records to produce cleaned data;
integrating, by the integrated analytics module, the cleaned data with the historical economic datasets stored in the data storage module to produce a structured dataset;
generating, by the artificial intelligence predictive modeling module, predictive models that forecast ripple effects of token activity on liquidity and revenue;
computing, by the tokenomics quotient calculation module, the Tokenomics Quotient (TQ) based on token velocity, liquidity, retention, transaction diversity, and regional adoption;
mapping, by the geo-fenced mapping module, token flows and lifecycle events within the predefined geographic boundaries to generate heat maps and token journey paths; and
presenting, by the dashboard visualization module, real-time insights comprising the Tokenomics Quotient (TQ), predictive forecasts, and geo-fenced visualizations via the interactive user interface.

12. The method of claim 11, further comprising computing, by the integrated analytics module, an Economic Velocity Rate that represents velocity of state-funded operating capital within a closed-loop network over a parameterized time window and jurisdiction.

13. The method of claim 12, wherein computing the Economic Velocity Rate comprises applying a configurable circulation threshold N and incorporating token class, program identifier, jurisdiction, merchant category, and recapture events.

14. The method of claim 12, further comprising rendering, by the dashboard visualization module, dashboards that display the Economic Velocity Rate by geography, program, vendor class, and time window and returning the Economic Velocity Rate via the external interfaces module.

15. The method of claim 12, further comprising detecting, by the artificial intelligence predictive modeling module, anomalous transaction patterns using the Economic Velocity Rate to identify rapid-loop circulation, related-party clustering, or velocity manipulation.

16. The method of claim 11, further comprising generating, by the geo-fenced mapping module, a zone alert responsive to a threshold-exceeding change in token transaction density or directional flow within one of the predefined geographic boundaries.

17. A non-transitory computer-readable medium storing instructions that, when executed by one or more processors, cause operations comprising: ingesting token transaction data and external economic indicators;
cleansing and standardizing the token transaction data to form cleaned data;
joining the cleaned data with historical economic datasets to generate the structured dataset;
applying trained models to the structured dataset to forecast liquidity shifts, revenue trajectories, and macroeconomic ripple effects;
computing the Tokenomics Quotient (TQ) using token velocity, liquidity, retention, transaction diversity, and regional adoption;
rendering geo-fenced visualizations of token lifecycle events; and
generating a user interface that presents real-time insights, the Tokenomics Quotient (TQ), and compliance alerts.

18. The non-transitory computer-readable medium of claim 17, wherein the instructions further cause the operations to encrypt communications among the central processing unit, the integrated analytics module, the artificial intelligence predictive modeling module, and the external interfaces module.

19. The non-transitory computer-readable medium of claim 17, wherein the instructions further cause the operations to record blockchain-anchored immutable references for the real-time logs and the predictive modeling artifacts using the network communication module.

20. The non-transitory computer-readable medium of claim 17, wherein the instructions further cause the operations to enforce role-based access controls and tenant scoping in responses returned by the external interfaces module so programmatic access is filtered by jurisdiction, program, and user role.
